(19) United States
(12) Patent Application Publication
(10) Pub. No.: US 2005/0259256 A1
(43) Pub. Date: Nov. 24, 2005

(54) Device and method for measurement

(76) Inventors: Dario Anselmetti, Werther (DE); Jan Rogener, Hamburg (DE); Marc-Oliver Schierenberg, Herzogenauaurach (DE); Franka Kalman, Steinen (DE)

Correspondence Address: WENDEROTH, LIND & PONACK, L.L.P., 2033 K STREET N. W., SUITE 800, WASHINGTON, DC, 20006-1021, US

(21) Appl. No.: 10/522,830

(22) PCT Filed: Jul. 30, 2003
(86) PCT No.: PCT/EP03/50350

§ 371 Date: Feb. 18, 2005

(30) Foreign Application Priority Data
Jul. 31, 2002 (CH) 2002 1344/02

(51) Int. Cl. G01N 21/64; G01N 27/453

(52) U.S. Cl. 356/344; 204/603; 356/318

(57) ABSTRACT

1D or 2D flat-bed electrophoresis or flat-bed chromatography can be used to determine unseparated and separated substances directly, and without any prior labelling, if their inherent fluorescence in the UV range which is excited by irradiation with UV light in the wavelength range 140 to 320 nm is measured using a UV detector.

The present invention relates to a device possessing a UV radiation source, optical elements for conducting UV excitation radiation, a flat-bed electrophoresis separation medium on which unstained, discrete spots of electrophoretically separable substances are located, optical elements for conducting UV fluorescence radiation, and a UV detector. The device is used for directly measuring, and for detecting, electrophoretically separable substances by means of natural fluorescence radiation in the UV range.

Electrophoresis, and in particular gel electrophoresis, have for a long time now proved their value for separating electrically charged molecules in accordance with mass and/or electric charge. The method is employed for qualitatively and quantitatively analysing pharmaceutical active compounds and pesticides, as well as their metabolites, and for separating and investigating amino acids, oligopeptides and polypeptides (proteins), DNA, RNA, monomeric, oligomeric and polymeric saccharides, and other biological substances, in cells and body fluids. Gel electrophoresis, in particular, has recently increased in importance in connection with investigating cells (proteomics). Apart from gel electrophoresis in columns (Tiselius apparatus) for the preparative scale, known methods include capillary gel electrophoresis, for separating microquantities, and flat-bed electrophoresis using various planiform inorganic- or organic-based separation media (silica gels, metal oxides, paper, celluloses, agarose gels, dextran gels, polymer gels, membranes and, in particular polyacrylamide gels) in horizontal or vertical electrophoresis equipment. The electrophoretic separation can be carried out in accordance with a variety of separation mechanisms, for example in accordance with the ratio of size to charge, in accordance with dissimilarity in isoelectric points (isoelectric focusing), or in accordance with size, for which gradient gels or charged SDS complexes are used. A combination of isoelectric focusing and SDS-PAGE electrophoresis is termed 2-D gel electrophoresis, which has become established, in particular, in connection with cell investigations (proteomics). If the separation is carried out on flat supports in only one dimension, it is then referred to as being 1-D flat-bed electrophoresis.

Substances to be analysed are advantageously detected by means of spectroscopic methods such as absorption or fluorescence, with the recording of the absorption spectrum, and the measurement of a luminescence radiation at characteristic wavelengths, customarily being employed in capillary electrophoresis [see, for example, U. B. Soetebeer et al. in Journal of Chromatography B, 745 (2000), pages 271 to 278] or liquid chromatography (HPLC). The gels which are used in capillary gel electrophoresis are liquid (ion-exchange gels) and measurements of natural fluorescence do not, in this case as in liquid chromatography, represent a problem since hardly any interference, as regards the absorption and background radiation of the liquids, is observed.

In the case of 1D- and 2D-flat-bed electrophoresis, in which solid separating media are employed, it has not thus far been possible to use absorption to determine invisible substances with the requisite degree of sensitivity since the background of the separation media (support and buffer system) is too high in the low UV range (190 to 280 nm). Nor has it been possible to eliminate this problem using very thin, UV-transparent gels.

Use is therefore usually made of substance-specific staining methods for the purpose of visualizing, and where appropriate quantifying, after the separation and directly or by way of digital imaging methods, the regions (spots, lanes) occupied by the substances on the surfaces. In “Staining nucleic acids and proteins in electrophoresis gels”, Biotech. Histochem. (2001) 76(3), pages 127-132, L. R. Williams provides a review of the different staining methods. In general, it is necessary, before performing a substance-specific staining, to use a fixative to fix the samples to the gel in order to avoid any “bleeding-out” in the staining and destaining solutions during the staining reaction, something which can of itself give rise to undesirable changes.

Known methods for visualizing proteins are staining with amido black [C. M. Wilson, Anal. Biochem. 6, pages 263 to 278 (1979)] or with Coomassie blue dye [S. Fazekas de St. Groth et al., Biochim. Biophys. Acta 1, pages 377-391 (1963)], in which, however, the low sensitivity is found to be a particular disadvantage. An advantage is, however, that the different polypeptides react quantitatively with dyes.

A method in protein analysis which is sufficiently sensitive is the deposition of silver ions and their binding to proteins [B. R. Oakly et al., Anal. Biochem. 105, pages 361-363 (1980)] (i.e. silver staining), in which method, however, the small dynamic range and interference with subsequent investigations are of particular consequence. Another disadvantage of this staining method is that, during staining, there is discrimination between different proteins, that is some proteins stain strongly while others stain less strongly. It is not possible, in unknown protein samples, to estimate the relative quantity or frequency of the different proteins, something which is, however, one of the basic prerequisites in the field of cell investigation research (proteomics).

In a more recent publication [Analytical Biochemistry 301, pages 91 to 96 (2002)], D. Kazmin et al. propose treating tryptophan-containing proteins with trichloroacetic acid or chloroform under UV light and visualizing the regions occupied by the proteins, which have been separated in a polyacrylamide gel, by means of the excited, visible fluorescence radiation (natural fluorescence of the modified tryptophan). The spectrum of the native fluorescence is consequently displaced from the UV range into the visible range.

Another known method is that of staining, after the electrophoretic separation, with dyes which fluoresce in the visible range. An advantage is the high degree of linearity of the dependence of the measured intensity on the quantity (dynamic range). However, it is particularly disadvantageous that the treatment with chemicals can lead to low molecular weight substances being washed out and not being detected. In addition, the possibility of substances being altered in connection with the action of the chemicals cannot be ruled out, which means that it is not possible to guarantee that all the substances in the sample react quantitatively.

Similar or identical disadvantages exist when the substances are stained with fluorescent dyes, with the dye being covalently bonded, before they are separated. This is a common method for analysing proteins since it ensures highly sensitive, quantitative detection. However, the great disadvantage of this technique is that the substances in the analytical samples are chemically altered (both mass and isoelectric point) and only special systems, which are developed for specific dyes, can be used for the detection. The method is therefore uneconomical. Furthermore, the presence of fluorescent dyes can interfere with subsequent investigations, for example mass-spectrometric measurements.

In general, dyes are removed once again prior to a mass-spectrometric measurement, prior to an enzymic digestion or prior to blotting, something which can in turn give rise to changes in the separated substances. Glycosylated proteins are particularly sensitive in this connection and can frequently not be detected. Furthermore, the additional procedural steps are time-consuming and give rise to chemical waste which has to be disposed of. In order to circumvent uncertainties, which are caused in this way, in connection with a measurement, use is frequently made of from two to 4 gel plates, with 2 being used as measurement plates and 2 being used as reference plates, with the aim of isolating the substances, for subsequent measurements, from the reference plates. This high consumption of materials is found to be a particular disadvantage.

In Analytical Biochemistry 191, pages 58-64 (1990), H. Yamamoto et al. describe a densitometric method for graphically depicting unlabelled, separated substances in connection with 2-D gel electrophoresis, in which method the absorption spectra of the substance regions are recorded, by selecting suitable wavelengths, in the UV range through to the visible range. The method is not sufficiently sensitive and is not suitable, in particular, for the requirements, which have recently arisen, with regard to the analysis of proteins (proteomics).

Thus far, there has been no disclosure of any method for directly determining substances, which can be separated electrophoretically by means of 1D or 2D flat-bed electrophoresis (abbreviated as PAGE when using polyacrylamide gels), without any pretreatment or modification of the substances, in particular when determining and visualizing proteins in acrylamide gels or other solid gels (which are usually crosslinked). Such a method is extremely desirable in order to avoid the abovementioned disadvantages, for example low sensitivity, fixing, destaining, labelling, different strengths of the staining in the case of different substances (proteins), and alteration of the substances (proteins) as a result of covalently bonded dye.

It has now been found, surprisingly, that direct measurement and/or graphic depiction is possible in connection with 1D or 2D flat-bed electrophoresis and flat-bed chromatography (thin layer chromatography) when the inherent fluorescence, in the UV range, of electrophoretically separable substances is excited with UV radiation and measured. The dynamic range is unexpectedly high and it is also possible to use the measurement to detect glycosylated proteins directly. Furthermore, the sensitivity of the measurement is surprisingly high, such that it even becomes possible to effect detections in the range from 1 to 5 nanograms per band. The direct measurement is therefore particularly suitable for detecting small quantities of substance, for example cell lysates.

The invention firstly relates to a device possessing the following components:
a) a UV source (1) for excitation light in the wavelength range from 140 to 320 nm;
b) a separation medium (2) for a flat-bed electrophoretic separation of electrically charged substances, or a separation medium (2) for a flat-bed chromatographic separation of electrically charged or neutral substances;
c) regions, which are distributed in the separation medium (2), of substances which are to be separated and which have been separated and which are also unlabelled, which substances emit, on excitation with the said UV source (1), UV fluorescence in the wavelength range from 150 to 400 nm;
d) a UV detector (3) for the UV fluorescence radiation; and
e) optical or optoelectronic components for filtering, guiding and/or amplifying the excitation radiation and the fluorescence radiation.

The UV source (1) can be lasers or UV lamps, for example mercury vapour lamps, KrF lamps, Xe flashlight lamps, excimer gas emission lamps (e-lamp, from TuiLaser) or lasers for monophoton or polyphoton excitation. When lamps are used, the desired wavelength can be established by connecting in optical filters, gratings or other optical elements, and can be focused with lenses in order to generate sufficient energy density. The lasers can be continuous lasers or pulsed lasers having pulse lengths in the range from femtoseconds to milliseconds. UV lasers are frequently frequency-multiplied lasers which generate radiation in the visible range. The radiation can be directed onto the gel in a direct and focused manner or as an expanded beam, as well as by means of multiple illumination. The power density and the energy density are selected such that a measurable fluorescence signal is produced without at the same time damaging the substances to any significant degree. The energy density can, for example, be from 0.1 to 3500, preferably from 1 to 500, and particularly preferably from 1 to 50, mJ/cm² in one second. Values of about 35 mW/cm² in one second are particularly suitable when measuring proteins. These UV light sources are commercially available. A Spectra Physics laser (Tsunami model), which operates at a wavelength of 280 nm (frequency of 840 nm), 80 MHz and 100 femtoseconds pulse length, and which has a power output of 150 mW, has proved to be particularly suitable. A frequency-quadrupled Nd:YAG laser system (266 nm wavelength, 500 ps pulse length, 4 mW power output) from JDS Uniphase has likewise proved to be particularly suitable.

The wavelength of the exciting UV light is preferably from 140 to 320, and particularly preferably from 220 to 300, nm.

The separation medium (2) can consist of different planiform materials. They should not be soluble in the mobile phase employed and they must be dielectric. The materials can be inorganic materials, for example metal oxides and salts such as silicates. Some examples are aluminium oxide, titanium oxide, silica gels and kieselguhr. Other suitable materials are papers and celluloses. Gel-forming polymers which are crosslinked, where appropriate, such as polyacrylamide gels, agarose gels and dextran gels, are particularly suitable materials.

For the separation and/or the subsequent measurement, the separation medium can be applied to a dielectric or electrically conducting support, for glass, quartz or plastics, metal oxides and metals. Materials which reflect UV radiation, for example polished metal plates or metal-coated plastic plates, are particularly suitable for this purpose.

Many separation media for electrophoretic separation are known, described in the literature and available commercially. They are not therefore described here in any detail. It may, however, be mentioned that it is principally gels based on polyacrylamides which are used for the important field of protein separation. In order to be able to achieve a high degree of measurement sensitivity, the separation media advantageously exhibit low UV absorption and UV fluorescence.

In the arrangement according to the invention, the electrophoretic separation medium can also be replaced with separation media for flat-bed or thin-layer chromatography, with these separation media also advantageously exhibiting low UV absorption and UV fluorescence. The chromatographic separation medium can consist of different planiform materials which are able to separate molecules possessing inherent fluorescence in the UV range on excitation with UV radiation, for example by means of differing absorption and/or in accordance with differing size. The materials should not be soluble in the mobile phase employed and are applied, where appropriate as a separating layer, on a support. The materials can also be finely divided inorganic materials, for example metal oxides and salts such as silicates. Some examples are aluminium oxide, titanium oxide, silica gels and kieselguhr. Other suitable materials are papers and celluloses. Gel-forming polymers, which are crosslinked where appropriate, such as polyacrylamide gels, agarose gels and dextran gels, which, as finely divided materials, can also form a layer on a support, are particularly suitable materials. Flat-bed chromatography can be used for both electrically charged substances and uncharged substances.

For the purpose of achieving surfaces which are as plane as possible, and protecting against drying-out and ageing, the separation media can be provided with a cover which is optically transparent both for the excitation light and the fluorescence light, since the irradiation is directed onto the gel and the fluorescence radiation is advantageously measured through the cover. Materials which are permeable to UV radiation are known. They can be plastics which are expediently designed as films. Quartz glass is also very well-suited.

The substances can be distributed in the separation medium in a unidimensional or bidimensional direction. The substances are not chemically modified for detection purposes. It has to be possible to excite them to emit UV light. Such substances contain, for example, aromatic or heteroaromatic residues and/or, where appropriate, conjugated unsaturated carbon double bonds or carbon-heteroatom double bonds or multiple nitrogen bonds. The heteroatoms can be selected from the group O, N, S and P. Furthermore, the substances contain electrically charged groups, for example acidic groups (for example carboxylic, phosphoric or phosphonic acid, boric or boronic acid, and/or sulphur or sulphonic acid groups) and/or basic onium groups (for example ammonium groups).

The separation media can be measured immediately after a separation operation; alternatively, the samples can be stored. Prior to storage, substance regions in the separation media are fixed in a manner known per se; in the case of gels used for the protein separation, this is done, for example, by treating with alcohols such as methanol or ethanol.

The wavelength of the fluorescence radiation is preferably from 150 to 400, and particularly preferably from 230 to 400, nm.

The measurement principle is explained using proteins as the substance. Proteins can contain the amino acids phenylalanine, tryptophan and/or tyrosine, whose emission maxima are at the wavelengths 282 nm, 303 nm and, respectively, 348 nm. The extinction coefficient is high in the wavelength range from 200 to 320 nm, and proteins are therefore particularly suitable for the measurement principle according to the invention. Many organic substances containing the previously mentioned structural elements exhibit similar properties and are accessible to being measured with the device according to the invention, with these substances also including, for example, genetic material (DNA or RNA), which latter can be separated electrophoretically.

The UV detector (3) can be a photodetector for measuring fluorescence intensity, many kinds of which are available commercially. Examples of suitable detectors are photomultipliers, photodiodes (semiconductor diodes or semiconductor diode arrangements or arrays) and UV-sensitive CCD cameras. CCD cameras (electronic cameras with digital image recording and reproduction) are preferred. UV-sensitive CCD cameras are marketed, for example, by the Andor company (USA).

The components (d) can be optical filters for excluding unwanted background radiation and/or scattered radiation, which filters are arranged in the beam path between the plate (3) and the UV detector. It is also possible to use optical filters for setting the wavelength of the excitation light and for excluding unwanted radiation originating from the UV light source. The components can also be mirrors, prisms or diffractive elements for deflecting or collecting excitation light. Lenses or lens systems which are used for guiding or focusing radiation are also expedient. Spherical lenses can be employed for widening a laser beam. It is also possible to employ light amplifiers (residual light amplifiers) for increasing sensitivity. Stopping-down elements, which permit irradiation in defined time intervals, can also be arranged between the UV light source and the plate (3).

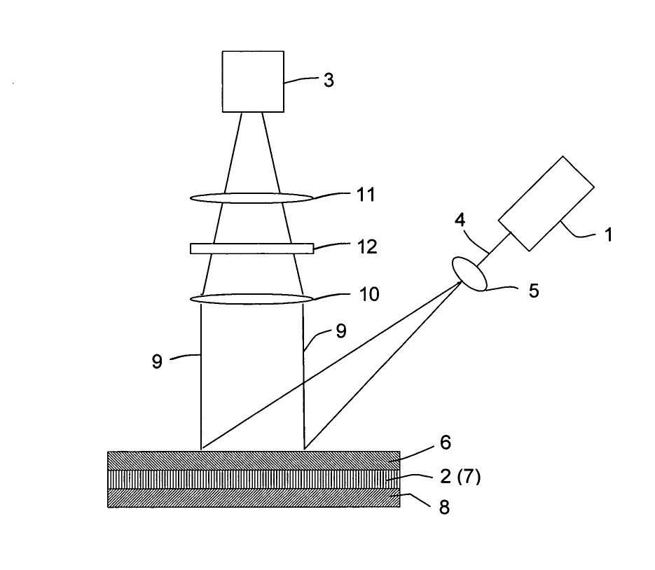

FIG. 1 shows an embodiment of a device according to the invention. The laser beam (4) of a UV laser (1) is widened by a convex lens (5) and directed onto a cover (6) of the separation medium (2). The cover protects a layer of acrylamide gel (7) which is applied on a stainless and polished steel plate (8). Regions of separated substances, which, on irradiation, generate UV fluorescence (9), are located in the acrylamide gel, being distributed over the surface. The fluorescence radiation (9) is conducted to a UV detector (3), for example a UV-sensitive CCD camera, by way of spherical lenses (10) and (11) between which a band-pass filter (12), for example for the wavelength range 300-375 nm, is arranged.

The arrangement according to the invention is outstandingly suitable for directly measuring substances in the separation medium (for example a gel) of a plate for 1D or 2D gel electrophoresis, or separation media for flat-bed chromatography, without the substances having to be labelled before or after the separation. The unseparated or separated substances (analytes) can even be transferred in a simple manner, by means of blotting (effect of an electric field acting perpendicularly to the plane of the separation medium), directly onto an applied membrane and, using the arrangement according to the invention, measured directly employing unlabelled antibodies. As compared with standard methods which are used, the method offers substantial advantages:
a) the use of chemicals for measuring/visualizing is completely avoided;
b) the time taken for the measurement is substantially reduced;
c) the alteration of substances as a result of being modified with chemicals, and the washing-out of substances as a result of the modification method, are completely avoided;
d) chemical aftertreatment for subsequent investigations, for example by means of mass spectroscopy, is avoided;
e) avoidance of a preparative separation as compared with standard methods, in which an analytical separation and a preparative separation are carried out in parallel in order to provided unmodified substances for subsequent investigations;
f) detection of all substances in a mixture to be separated, for example glycoproteins as well in the case of protein mixtures;
g) very high sensitivity, comparable to that with silver labelling, and, in addition, a high dynamic range as when labelling with dyes and fluorophores;
h) measurement of substances which are not modified with dyes/fluorophores;
i) no significant decomposition of proteins by UV irradiation up to at least 35 mJ/cm², as can be demonstrated by means of mass spectroscopy performed on known proteins;
j) no additional use of separation media as reference material.

The invention also relates to a method for determining substances which are separated by means of 1D or 2D flat-bed electrophoresis, in which method unseparated and separated substances are irradiated, in the separation medium for electrophoretic separations, with a light source and emitted fluorescence light is measured using a detector, characterized in that (a) by means of the action of UV light in the UV range, fluorescence-emitting substances (b) in the separation medium are irradiated directly with UV light of a wavelength of from 140 to 320 nm and (c) the UV fluorescence is measured at wavelengths of from 150 to 400 nm using a UV-sensitive detector. The method can also be employed for separation media in flat-bed chromatography in which it is possible to separate electrically charged or uncharged substances.

The embodiments and preferences which were previously described for the device also apply to the method.

The digital image of the sample can be produced in a variety of ways:
1) The entire surface is excited to fluoresce at one and the same time and a digital camera records an image of the whole separation medium.
2) The sample is surveyed in segments and the individual elements are assembled into an overall image in the computer. In this connection, a segment can be as small as desired (limited by the laser focus of approx. 200 nm) or as large as desired (as in 1). A segment can in turn be an image (e.g. contain several spots) or only be a point in the subsequent image (the scanner principle). The smaller the segment which is selected, the more efficiently can the fluorescence light be collected. An increased collecting efficiency shortens the measurement time, reduces potential UV damage to the measured substances and improves the sensitivity of the apparatus. In order to survey the entire sample in accordance with the scanner principle, a) the sample itself can be moved, b) the detector can be moved, c) the excitation source can be moved, d) the excitation and emission light can be deflected, or combinations of a)-d) can be employed. If only one point or one line is excited, the background fluorescence (e.g. of the cover an/or the sample mounting) can be greatly reduced by confocal detection.

The sample or segments of the sample can be surveyed repeatedly in order to obtain a better detection limit.

UV lasers which, by way of the principle of frequency multiplication, are commercially available for a variety of wavelengths are advantageously used for the method according to the invention. The lasers can be continuous or pulsed. Pulsed lasers are particularly suitable with lasers possessing different pulse lengths, which can be in the range of microseconds to femtoseconds, being known. Short pulse lengths in the femtosecond range are particularly advantageous since the excited fluorescence radiation has a lifetime which essentially lies between the individual pulses, which means that only little, or no, excitation radiation falls on the UV detector. The excitation radiation is advantageously beamed in at an angle of less than 90° to the perpendicular of the plate (8).

The measurement can be performed in different variants. In principle, the excitation light can be widened such that the entire separation medium is illuminated, something which is possible, for example, when the edge lengths are not too large. The plate can be illuminated once or several times in order to achieve a fluorescence radiation which is adequate for the measurement.

The method is very variable. In particular, the conditions can be adjusted such that photosensitive substances are spared and decomposition can to a large extent be suppressed. The method is also suitable for automation and standardization with this being of particular value for an industrial application.

When a UV spectrometer is used as the UV detector, the substance regions can also be determined spectrometrically, for example over a wavelength range of from 180 to 400 nm. In this way, it is also possible to use characteristic wavelengths of the fluorescence radiation to identify specific substances directly on the separation medium, or after the separated substance regions have been determined using UV detectors.

With regard to removing the substance regions for further investigations such as mass spectrometry (MALDI-MS) or other methods, account must be taken of the fact that the substances are colourless, and therefore invisible, and not discernible with the naked eye. One option for the removal consists in preparing a transparent negative film on plastic films, for example, which film can be laid on the surface of the separation medium (gel) for the purpose of indicating the substance regions. Another possibility consists in automated removal using a suitable computer program which evaluates digital recordings and controls a mechanical device for removing samples. Another option is, for example, that of using a visible laser (laser pointer) to indicate the substance regions for manual removal.

The method according to the invention can be applied in all the fields in which substances are separated and investigated by means of gel electrophoresis or flat-bed chromatography. An important field is that of biochemical research for analysing body fluids or corresponding extracts and concentrates. The analysis of proteins (proteomics) is particularly important in this connection. The method can be used for diagnostic investigations in which the presence of specific substances indicates the existence of particular diseases. Furthermore, the method according to the invention can be used to investigate the distribution and breakdown (metabolism) of pharmaceutical active compounds and pesticides in body fluids of plants and animals, including homeotherms. The method can also be used for characterizing and/or determining the effect of active compounds (binding of active compounds to separated proteins or nucleotide sequences) and for monitoring the quality of active compounds. The method can furthermore be used for further investigation of proteins on separation media, in particular for analysing Western blots or similar methods in which separated substance regions are transferred from the separation medium to membranes and then determined by means of adding antibodies which are labelled with fluorescent dyes. A particular advantage of the method consists in detecting unlabelled antibodies by exciting them, and measuring their inherent fluorescence, in the UV range in accordance with the method of the invention (in this case, the membrane corresponds to the separation medium).

The method is very sensitive and even makes it possible to measure quantities of from 1 to 5 nanograms. The method is therefore particularly suitable for investigating very small quantities of substance.

For diagnostic investigations, the method is expediently automated and standardized with regard to sample workup, separation conditions, measurement conditions and evaluation after the separation such that determining one, or a few disease-specific substances provides reliable information for subsequent medical treatment. Diagnostic investigations are carried out using samples removed from the human or animal body or from plants, such as body fluids (blood, urine, blood plasma, gastric or intestinal juice or plant juices) or tissue samples, which are worked up (purification and concentration, chemical pretreatment or preparation of cell lysates), where appropriate, prior to the separation.

Flat-bed electrophoresis or flat-bed chromatography is employed widely in analysis and, very particularly, in release analysis. It is precisely in this application field that the device according to the invention or the method according to the invention can increase economic viability to a particularly high degree due to simplification of the methodological sequence and avoidance of chemical wastes.

The invention also relates to the use of the device according to the invention, or the use of the method according to the invention, for separating and determining disease-specific substances present in samples obtained from the human or animal body or from plants.

The following examples clarify the invention.

### EXAMPLE 1

### Separating the Proteins Present in a Cell Extract

The experimental setup corresponds to the setup shown in FIG. 1. A Spectra Physics UV laser (Tsunami®, 840 nm, 80 MHz, 100 fs pulse length, frequency triplication to 280 nm excitation light, power output 150 mW) is used as the UV light source. A diaphragm, which is used to establish a quadratic irradiation area of 1 cm edge length, is located between a convex lens (5) and the separation medium (2). The power density at the surface of the separation medium (2) is 40 mW/cm². The illumination time is 1 second. The UV detector employed is a commercially available UV-sensitive BCCD camera from LaVision Biotec Deutschland (QE>65%). The area of 1 cm² in size is imaged by way of 2 Nikon UV lenses (105 mm, f=4.5) and assembled into an overall image in a computer. A UV band-pass filter for the wavelength range from 300 to 375 nm is located between the two lenses. A total of 56 images are recorded for the chosen format of 8×7 cm (minigel; after swelling in three times-distilled water, about 20% larger than during the separation). For this purpose, the separation medium is moved manually in a 1 cm-spacing grid in a positioning table.

The separation medium (2) is applied to a stainless steel plate (8) as a 1 mm-thick layer of a commercially available polyacrylamide gel. The polyacrylamide gel is covered with a 1 mm-thick quartz plate (6).

The separation by means of 2-D gel electrophoresis is carried out as a combination of isoelectric focusing (IEF) using carrier ampholytes (first dimension) and SDS-PAGE (second dimension), in accordance with Klose, J. Methods Mol Biol 1999, 112, 147-172.

The IEF is carried out in gel-filled glass rods (diameter 0.9 mm, 7 M urea, 2 M thiourea, 3.5% acrylamide, 0.3% piperazinediacrylamide, and a total quantity of 4% carrier ampholyte pH 2-11). The proteins are derived from lysates of EA.hy 926 cells [Edgell, C, J. S. Proc Natl Acad Sci USA 1983, 80, 3734-3737]. About 10 μg of protein are applied to the anodic end of the IEF gels of 7 centimetres in length and focused for Vh 1842 under conditions of non-equilibrium pH gradient electrophoresis (NEPHGE). SDS-PAGE is carried out in a 15% acrylamide gel using the IEF gels as the stacking gel. The gel size is 70×60×1 millimetres.

After the separation, the proteins are fixed in the gel overnight (10% acetic acid, 50% ethyl alcohol and 40% three times-distilled water). Prior to measurement, a gel is washed for 45 min in 50 ml of three times-distilled water (in order to reduce the background fluorescence), laid on the steel plate and covered with a quartz glass plate.

The camera is used to record an image of the UV fluorescence; dark spots are formed due to false-colour depiction in the image processing. The depiction makes it easier to compare with the standard “silver-staining” method, in which the separated proteins are depicted as black spots. The image which is obtained is comparable with a separation which has been visualized using silver ions.

### EXAMPLE 2

### Determining the Sensitivity

The arrangement described in Example 1 is used. Invitrogen 1D gel plates (Karlsruhe, Germany, NOVEX 12% tris-glycine gel, 12 or 10 well, 1 mm thick, No. EC60052 or EC6005) (loaded with proteins of differing molecular weights) (lysozyme (14.6 kDa, chicken), bovine anhydrase (29 kDa), GAPDH (rabbit, 36 kDa), BSA (bovine, 66 kDa) and phosphorylase (rabbit, 97.4 kDa)) [lacuna]. The proteins are mixed in equal quantities and diluted in SDS buffer (NOVEX tris-glycine SDS denaturing sample buffer LC2676) such that, after loading onto the gel, 500, 250, 100, 50, 25, 10, 5 and 1 ng are present per band (per protein). The separation is effected in accordance with [Laemmli U.K., 1970, Nature 227:680-685], running buffer: NOVEX tris-glycine SDS running buffer LC2675); the sample migrates in at a constant 50 V for 10 minutes; the gel is then allowed to run (at a const. 145 V and for about 1.5 hours) until the solvent front (bromophenol blue, which is present in the sample buffer) has reached the lower end of the gels.

After the separation, the proteins are fixed in the gel as described in Example 1 and, prior to measurement, a gel is washed for 45 minutes in 50 ml of three times-distilled water, then laid on the steel plate and covered with a quartz glass plate.

After the separation, the separated regions are visualized in accordance with the procedure described in Example 1, as well as in accordance with the methods of silver labelling and staining with Coomassie Blue, and compared. The sensitivity in accordance with the procedure described in Example 1 gives a detection limit of from 1 to 5 ng, which is comparable with that of the silver-labelling method. In the method using Coomassie Blue, the detection limit is from 10 to 50 ng.

### EXAMPLE 3

### Use of a 286 nm Laser System

The experimental setup corresponds to that depicted in FIG. 1 and described in Example 1. However, a JDS Uniphase UV laser system (frequency-quadrupled Nd:YAG, 266 nm wavelength, 500 ps pulse length, 4 mW power output) is used as the UV light source. The gels as described in Example 2 are used as the separation system. It is demonstrated that using the substantially more economical laser system does not result in any difference, qualitatively or quantitatively, as compared with the results described in Examples 1 and 2. However, due to the lower output, it is necessary to illuminate for correspondingly longer (30 times longer).

### EXAMPLE 4

### Blotting Method Using a Nitrocellulose Membrane

It is demonstrated that, when the setup shown in FIG. 1, and the separation described in Example 3, are used, it is also possible to quantitatively detect proteins (polyclonal rabbit IgG antibody fragment), from Sigma Aldrich, product number I-5006), after they have been transferred to a nitrocellulose membrane and after they have been labelled with unlabelled antibody fragments (anti-rabbit IgG antibody fragments, from Sigma Aldrich, product number R-9130) at a spot diameter of 500 micrometres and with the concentration per spot being 1 ng, and even at still lower concentrations. This extends the application possibilities, for example in blotting methods.

1. Device possessing the following components:
a) a UV source (1) for excitation light in the wavelength range from 140 to 320 nm;
b) a separation medium (2) for a flat-bed electrophoretic separation of electrically charged substances, or a separation medium (2) for a flat-bed chromatographic separation of electrically charged or neutral substances;
c) regions, which are distributed in the separation medium (2), of substances which are to be separated and which have been separated and which are also unlabelled, which substances emit, on excitation with the said UV source (1), UV fluorescence in the wavelength range from 150 to 400 nm;
d) a UV detector (3) for the UV fluorescence radiation; and
e) optical or optoelectronic components for filtering, guiding and/or amplifying the excitation radiation and the fluorescence radiation.

2. Device according to claim 1, characterized in that the UV source is a laser, UV lamps or lasers for multiphoton excitation.

3. Device according to claim 1, characterized in that the UV source exhibits an energy density of from 0.1 to 3500 mJ per cm², as measured at the surface of the separation medium.

4. Device according to claim 1, characterized in that the wavelength of the excitation light is from 140 to 320 mm.

5. Device according to claim 1, characterized in that the separation medium is metal oxides, salts, papers, celluloses or crosslinked, gel-forming polymers.

6. Device according to claim 5, characterized in that the gel-forming polymers are polyacrylamides, agarose or dextran.

7. Device according to claim 1, characterized in that the separation medium (2) is a separation medium which is used in flat-bed chromatography (thin layer chromatography).

8. Device according to claim 1, characterized in that the separation medium is applied to a support and, where appropriate, provided with a UV-permeable cover.

9. Device according to claim 1, characterized in that the component c) substances contain aromatic or heteroaromatic residues and/or optionally conjugated unsaturated carbon double bonds and/or carbon-heteroatom double bonds and/or nitrogen multiple bonds and electrically charged groups.

10. Device according to claim 9, characterized in that the substances are proteins.

11. Device according to claim 1, characterized in that the UV fluorescence is from 150 to 400 nm.

12. Device according to claim 1, characterized in that the UV detector is a CCD camera, a photomultiplier, a semiconductor diode or a semiconductor diode arrangement.

13. Method for determining substances which are separated by means of 1D or 2D flat-bed electrophoresis, in which method unseparated and separated substances are irradiated, in the separation medium for electrophoretic separations, with a light source and emitted fluorescence light is measured using a detector, characterized in that (a) by means of the action of UV light in the UV range, fluorescence-emitting substances (b) in the separation medium are irradiated directly with UV light of a wavelength of from 150 to 320 nm and (c) the UV fluorescence is measured at wavelengths of from 150 to 400 nm using a UV-sensitive detector.

14. Method according to claim 13, characterized in that the separated substances are transferred from the separation medium to a laid-on membrane by applying an electrical field perpendicular to the plane of the separation medium.

15. Method according to claim 14, characterized in that the membrane is composed of nitrocellulose or polyvinylidene fluoride which are employed in Western blotting methods.

16. Method according to claim 14, characterized in that the transferred substance regions are treated with unlabelled antibodies and their inherent fluorescence in the UV range is then measured after exciting with UV radiation.

17. Use of the device according to claim 1, for separating and determining disease-specific substances in samples taken from the human or animal body or from plants.

18. Use of the method according to claim 13, for separating and determining disease-specific substances in samples taken from the human or animal body or from plants.
